(19) United States
(12) Patent Application Publication
(10) Pub. No.: US 2023/0001551 A1
(43) Pub. Date: Jan. 5, 2023

(54) MANIPULATOR AND PLACEMENT TOOL FOR CONDUIT-JOINING SLEEVE

(71) Applicant: Anthem Aviation LLC, Virginia Beach, VA (US)

(72) Inventor: Walter R. Averett, Virginia Beach, VA (US)

(21) Appl. No.: 17/826,228

(22) Filed: May 27, 2022

Related U.S. Application Data
(60) Provisional application No. 63/217,372, filed on Jul. 1, 2021.

(51) Int. Cl. B25B 27/10; F16L 13/14

(52) U.S. Cl. CPC B25B 27/10; F16L 13/141; F16L 2013/145

(57) ABSTRACT

A manipulator and placement tool for conduit-joining sleeve is an open-ended cylinder having a first half-cylinder and a second half-cylinder. The first and second half-cylinders are hingedly coupled to one another at first circumferential ends thereof. A retainer couples the first and second half-cylinders at second circumferential ends thereof. A first axial end of the open-ended cylinder is configured to slidingly receive an open-ended conduit-joining sleeve therein wherein the sleeve is fully encased by the open-ended cylinder. A second axial end of the open-ended cylinder has an annular ledge at an internal region of the open-ended cylinder. The annular ledge prevents the sleeve from passing axially through the second axial end.

Pursuant to 35 U.S.C. § 119, the benefit of priority from provisional application 63/217,372, with a filing date of Jul. 1, 2021, is claimed for this non-provisional application.

### FIELD OF THE INVENTION

The invention relates generally to tools used in the joining of conduits, and more particularly to a manipulator and placement tool for a rigid cylindrical sleeve used to join pneumatic lines or fuel lines onboard aircraft.

### BACKGROUND OF THE INVENTION

Pneumatic lines and fuel lines are used extensively throughout all types of aircraft. When ends of two pneumatic lines or ends of two fuel lines must be connected, it is common to employ what is known as a “Wiggins” fitting to create the necessary sealed connection between two lines. Since the integrity of pneumatic lines and fuel lines is critical for aircraft, proper Wiggins fitting installations are essential in aircraft maintenance. Briefly, a Wiggins fitting consists of an open-ended, rigid cylindrical sleeve and a cylindrical clamp. When properly positioned, the sleeve fits snugly over both ends of two lines that are to be connected and the clamp holds the sleeve in place.

During installation of a Wiggins fitting, the critical and tedious portion of the installation operation involves proper positioning of the sleeve without damaging the sleeve. The manipulation and proper placement of the sleeve can take multiple attempts spanning hours for four reasons. First, there is an extremely tight diametric mating tolerance between a sleeve and the portions of the two lines that the sleeve engages. Second, the sleeve's structural integrity must be pristine as any dimensional distortions, dents, and/or nicks in the sleeve can render the sleeve useless. Three, in order to properly position a sleeve to achieve the proper seal with the connected lines, an installation technician currently uses conventional tools (e.g., screwdrivers, hammers, wrenches, etc.) to apply a motive force to the sleeve during its manipulation and placement that frequently introduces unwanted dimensional distortions, dents, and/or nicks in the sleeve. Fourth, the locations of many of these line connecting operations are difficult for the installation technician to reach and/or see. As a result, the critical installation of a Wiggins-fitting sleeve is frequently difficult, time consuming, and frustrating.

### SUMMARY OF THE INVENTION

Accordingly, it is an object of the present invention to provide a tool for use in manipulation and placement of a Wiggins-fitting sleeve over ends of two lines that are to be connected and sealed.

Another object of the present invention is to provide a tool that ensures mechanical and structural integrity of a Wiggins-fitting sleeve during its installation over the ends of two lines that are to be connected and sealed.

Other objects and advantages of the present invention will become more obvious hereinafter in the specification and drawings.

In accordance with the present invention, a tool satisfying the above objects is provided. The tool is an open-ended cylinder having a first half-cylinder and a second half-cylinder. The first half-cylinder and second half-cylinder are hingedly coupled to one another at first circumferential ends thereof. A retainer couples the first half-cylinder to the second half-cylinder at second circumferential ends thereof. A first axial end of the open-ended cylinder is configured to slidingly receive an open-ended sleeve therein wherein the open-ended sleeve is fully encased by the open-ended cylinder. A second axial end of the open-ended cylinder has an annular ledge at an internal region of the open-ended cylinder. The annular ledge prevents the open-ended sleeve from passing axially through the second axial end.

### BRIEF DESCRIPTION OF THE DRAWINGS

Other objects, features and advantages of the present invention will become apparent upon reference to the following description of the preferred embodiments and to the drawings, wherein corresponding reference characters indicate corresponding parts throughout the several views of the drawings and wherein:

FIG. 1 is a cross-sectional view of the ends of two conventional pneumatic lines or two conventional fuel lines that are to be connected and sealed by a Wiggins fitting;

FIG. 2 is a cross-sectional view of the ends of the two lines in FIG. 1 with a conventional Wiggins-fitting sleeve properly positioned thereon;

FIG. 3 is a perspective view of a sleeve manipulator and placement tool illustrated in its closed position in accordance with an embodiment of the present invention;

FIG. 4 is an end view of the tool taken along line 4-4 in FIG. 3 illustrating its sleeve-receiving end thereof;

FIG. 5 is an end view of the tool in its open position as viewed from the sleeve-retaining end thereof;

FIG. 6 is a cross-sectional view of the tool taken along line 6-6 in FIG. 3;

FIG. 7 is an isolated side view of a tool closure retainer in accordance with an embodiment of the present invention;

FIG. 8 is a side view of a portion of a sleeve manipulator and placement tool employing an integrated detent-type tool closure retainer in accordance with another embodiment of the present invention;

FIG. 9 is a perspective view of a sleeve manipulator and placement tool having two fixed manipulator posts coupled to the sleeve-retaining end of the tool in accordance with another embodiment of the present invention;

FIG. 10 is a perspective view of a sleeve manipulator and placement tool illustrated in its closed position and having through holes in radial walls thereof in accordance with another embodiment of the present invention; and

FIG. 11 is a cross-sectional view of a tool further including a cushion material disposed on the tool's annular ledge in accordance with another embodiment of the present invention.

### DETAILED DESCRIPTION OF THE INVENTION

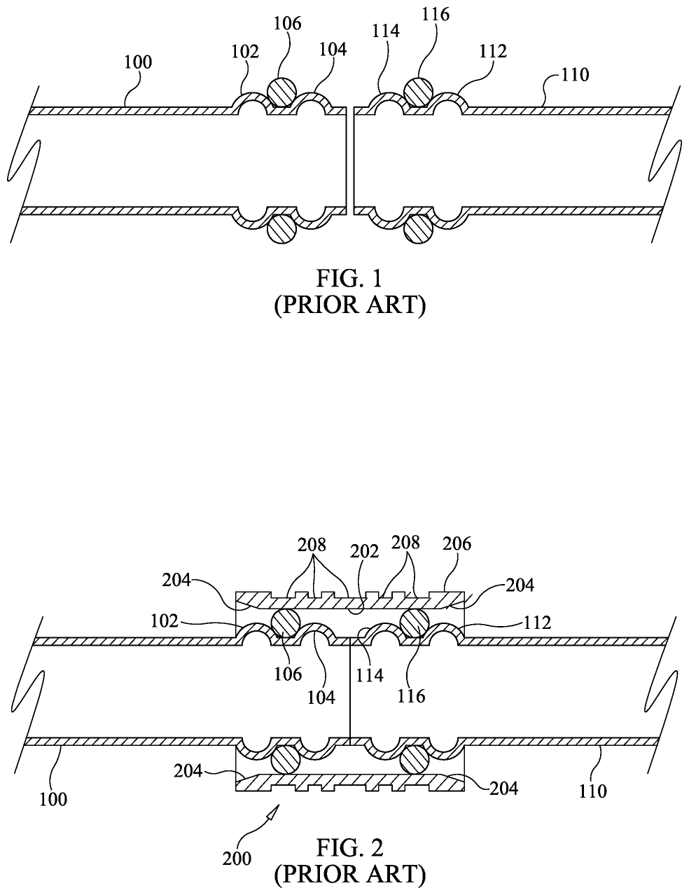

Referring now to the drawings, simultaneous reference will be made to FIGS. 1 and 2 where cross-sectional views of the ends of two pneumatic conduits/lines or fuel conduits/lines of the type that are generally connected using a Wiggins fitting. As is known in the art, a Wiggins fitting includes a cylindrical sleeve and a cylindrical clamp. The cylindrical sleeve and cylindrical clamp are not part of the present invention. FIG. 1 illustrates two conventional cylindrical lines 100 and 110 prior to the joining thereof by a cylindrical sleeve of a Wiggins fitting. As is known in the art, lines 100 and 110 are typically in axial alignment with one another (as shown) prior to the installation of a Wiggins-fitting sleeve. FIG. 2 illustrates lines 100 and 110 after a Wiggins-fitting sleeve 200 (hereinafter referred to simply as sleeve 200) has been properly manipulated and placed such that a portion of each line 100 and 110 is fitted in sleeve 200. It is critical that sleeve 200 be properly positioned without incurring any damage.

As is known in the art, lines 100 and 110 are configured identically in terms of their end structure. That is, the outboard end of line 100 has two spaced-apart annular ferrules 102/104 with an O-ring 106 captured there between. Similarly, the outboard end of line 110 has two spaced-apart annular ferrules 112/114 with an O-ring 116 captured there between. Sleeve 200 has a smooth inside surface 202 that sealingly engages O-rings 106/116 when sleeve 200 is properly positioned over the ends of lines 100 and 110 as illustrated in FIG. 2. The axial ends of sleeve 200 at inside surface 202 are tapered radially outward at 204 to facilitate manipulation of sleeve 200 during a placement operation. Sleeve 200 is configured such that its axial length causes all annular ferrules 102, 104, 112 and 114 to be encased within sleeve 200 when sleeve 200 is properly positioned as shown in FIG. 2. Outer surface 206 of sleeve 200 has multiple annular grooves 208 that mate with portions of a conventional Wiggins clamp (not shown) once sleeve 200 is properly positioned as shown in FIG. 2. Installation of a conventional Wiggins clamp on a properly positioned sleeve 200 is a straightforward and well-known operation that is not a limitation of the present invention.

As mentioned previously herein, the tight tolerances between lines 100/110 and sleeve 200 make the manipulation and placement of sleeve 200 a difficult task without applying some type of mechanical pressure or force to an axial end of sleeve 200 and/or an external radial face of sleeve 200. Unfortunately, the need to maintain shape/size integrity of sleeve 200 to ensure a perfect seal with O-rings 106/116 makes it extremely difficult to apply non-damaging axial or radial forces to sleeve 200 using conventional aircraft maintenance tools such as screwdrivers, hammers, wrenches, etc.

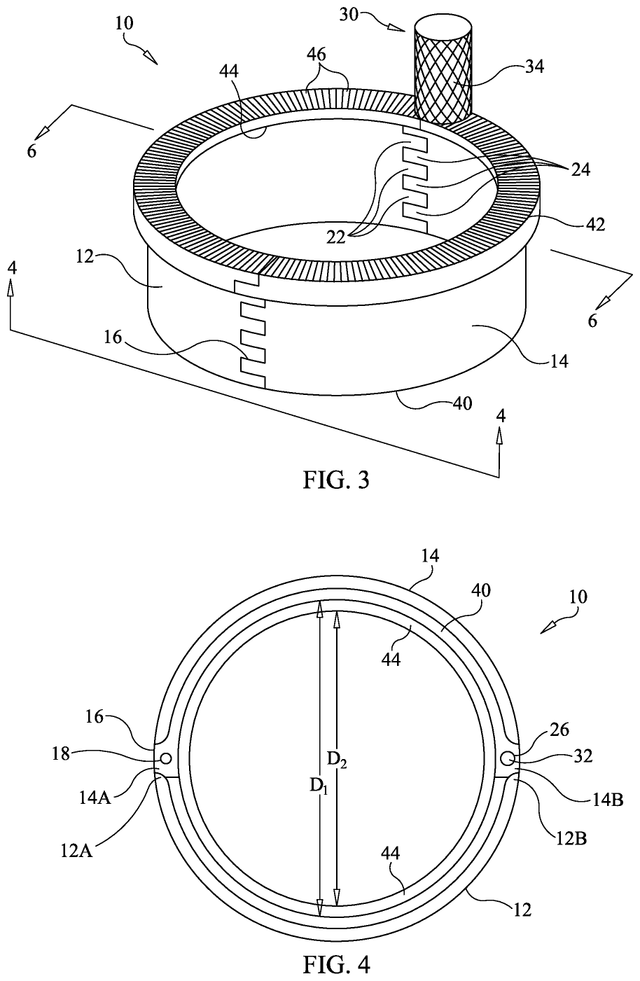

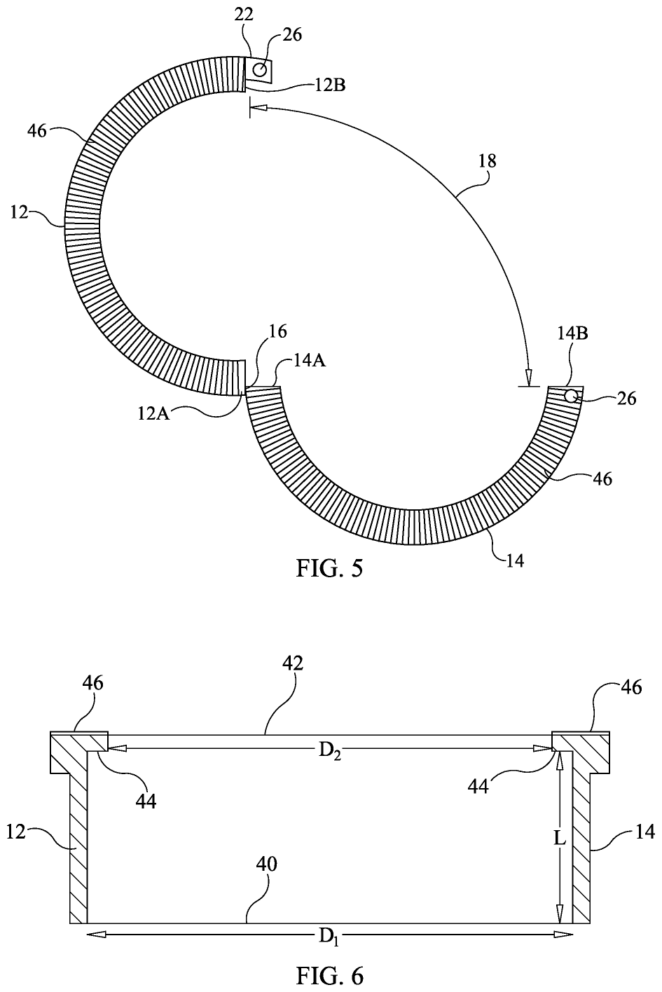

The present invention is a tool that provides for manipulation of sleeve 200, assures proper placement of sleeve 200, protects and guarantees shape/size integrity of sleeve 200, and drastically reduces the time required for proper/safe manipulation/placement of sleeve 200. Referring now simultaneously to FIG. 3-6, a sleeve manipulation tool in accordance with an embodiment of the present invention is shown in a perspective view (FIG. 3), in two axial end views thereof (i.e., tool is closed in FIG. 4 and open in FIG. 5), and in a cross-sectional view thereof (FIG. 6). The tool is referenced generally by numeral 10. It is to be understood that some features of tool 10 to be described herein will not be visible in all views thereof. Tool 10 can be made of a rigid material(s) typically used in the manufacture of machine tools and can include stainless steel. In some embodiments of the present invention, tool 10 can be made from a magnetic material (e.g., a tool steel such as 304 stainless steel) to facilitate the retrieval of the tool if it is dropped in an area that is difficult to access by hand.

Tool 10 has two sections 12 and 14, each of which is a half-cylinder as best seen in FIG. 5. One circumferential end 12A of section 12 is hingedly coupled to one circumferential end 14A of section 14 at a hinge joint 16 that can be configured as a finger joint hinge. As would be understood in the art, a hinge pin 18 (FIG. 4) passes through finger joint hinge 16 such that sections 12/14 can rotate about hinge pin 18. In some embodiments of the present invention, finger joint hinge 16 can be configured such that sections 12 and 14 can experience relative rotation of at least 90° as indicated by two-headed arrow 18 (FIG. 5) such that each of half-cylinder sections 12 and 14 is unencumbered by the other half-cylinder section when tool 10 is fully opened as shown in FIG. 5. In this way, either half-cylinder section 12 or 14 is readily positioned about a Wiggins fitting sleeve as will be explained further below.

Sections 12 and 14 are separably coupled to one another at their respective second circumferential ends 12B and 14B. More specifically, circumferential end 12B of section 12 has finger joint features 22 that are interlaced with finger joint features 24 provided on circumferential end 14B of section 14 when tool 10 is in its closed position (FIG. 3). In the illustrated embodiment, each of finger joint features 22/24 has a hole 26 there through such that all holes 26 are axially aligned with each other when tool 10 is in its closed position thereby allowing tool 10 to assume an open-ended cylinder configuration in its closed position. A shaft or pin 32 of a retainer 30 engages aligned holes 26 (as best seen in FIG. 4) thereby retaining tool 10 in its closed position.

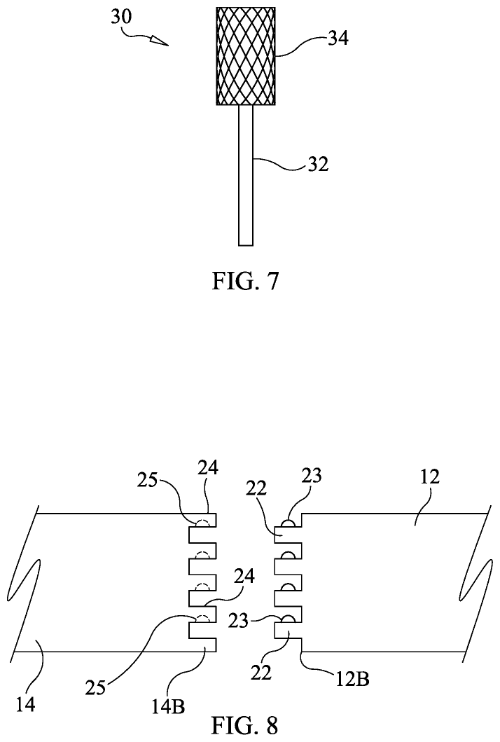

Referring additionally now to FIG. 7, retainer 30 has its pin 32 with a diameter sized to slidingly fit in aligned holes 26. Pin 32 terminates in a larger diameter head or post 34 whose outer surface can be knurled. Post 34 is readily grasped by an installation technician and used to place/remove retainer 30, but can also be used to help manipulate tool 10 when it is being used to properly position a sleeve 200 about two lines as shown in FIG. 2 and as described above. Retainer 30 can be, but need not be, tethered to one of sections 12 or 14 so that retainer 30 remains with tool 10 even when not coupling circumferential ends 12B and 14B.

When in its closed position as shown in FIGS. 3, 4 and 6, one open axial end 40 of tool 10 has a diameter “D₁” sized to slidingly receive the entirety of a Wiggins-fitting sleeve such as the above-described sleeve 200. That is, the entirety of a Wiggins-fitting sleeve will fit axially within tool 10 to be encased thereby. The other open axial end 42 of tool 10 in its closed position is configured to define an interior annular ledge 44 that extends partially and radially into tool 10 to form a stop for the sleeve fitted in tool 10 thereby preventing an encased sleeve from exiting open axial end 42. The interior axial length “L” (FIG. 6) of tool 10 measured from open axial end 40 to interior annular ledge 44 is equal to or greater than the axial length of a sleeve that tool 10 will be used to manipulate and position thereby ensuring that the sleeve is protected. When tool 10 is in its closed position, the inside diameter “D₂” defined by annular ledge 44 (FIG. 4) is larger than the outside diameter of a line it will be disposed about, but smaller than the outside diameter of the pneumatic or fuel lines' annular ferrules (e.g., previously-described annular ferrules 102/104 or 112/114). The axial external end face of end 42 (formed when sections 12 and 14 are joined together at circumferential ends 12B and 14B, respectively, as described above) can include indentations for cooperation with a conventional or specialized tool used to apply force to axial end 42 as will be explained further below. In the illustrated example, the indentations comprise a plurality of radially-extending grooves 46. Grooves 46 define a plurality of circumferential placement points for engagement with, for example, a flat-head screwdriver (not shown) that can be used to safely apply axial pressure to tool 10 when manipulating/placing a sleeve as will be described further below.

To use tool 10, a sleeve (e.g., sleeve 200) is positioned on a first line that is to be joined but away from its ferrule/O-ring end. For example, the first line's O-ring can be temporarily removed thereby allowing the sleeve to be readily slid over the line's annular ferrules. The O-ring is then re-installed between the first line's annular ferrules. Tool 10 is opened and one of half-cylinder sections 12 and 14 is placed about the sleeve with its open axial end 40 located closest to or facing the first line's ferrule/O-ring end. Tool 10 is closed about the sleeve and is retained in its closed position about the sleeve and line by retainer 30 as described above. At this point, tool 10 completely encases and protects the sleeve. With the sleeve fully protected, forces can be applied to axial end 42. To facilitate the application of force to tool 10, indentations can be provided in the axial external end face of end 42 as mentioned above. For example and as shown in FIGS. 3, 5 and 6, the indentations can be configured as radially-extending grooves 46 for ready engagement with a conventional tool such as a flat-head screwdriver. Axial pressure can be applied to end 42 in increments at different circumferential locations on axial end 42. The axial pressure applied to tool 10 is distributed evenly about the axial end of the sleeve by annular ledge 44.

The manipulation of tool 10 along with the encased/protected sleeve proceeds over the first line's ferrule/O-ring end and, subsequently, over the ferrule/O-ring end of the to-be-joined second line. The inside diameter D₂ defined by the interior of annular ledge 44 causes annular ledge 44 to engage with the first of two annular ferrules on the first line to prevent further axial movement of tool 10 and the sleeve encased thereby. When this occurs, the sleeve is properly positioned over both lines (as shown in FIG. 2) and tool 10 can be opened and removed. All such manipulation and placement of the sleeve occurs while the sleeve is completely encased and protected by tool 10.

In some embodiments of the present invention, the separable circumferential ends 12B and 14B of sections 12 and 14, respectively, can include an integrated closure retainer that eliminates the need for the above-described removable retainer 30. For example, FIG. 8 illustrates the circumferential ends 12B and 14B of sections 12 and 14, respectively, with their corresponding finger joint sections 22 and 24 employing detent-type retention features. More specifically, some or all of finger joint sections 22 include a protrusion 23 that provides a detent engagement with a corresponding depression 25 provided in corresponding finger joint sections 24 when sections 12/14 are pivoted into engagement with one another. The engagement of each protrusion 23 with a corresponding depression 25 serves to retain sections 12 and 14 in the closed position of tool 10.

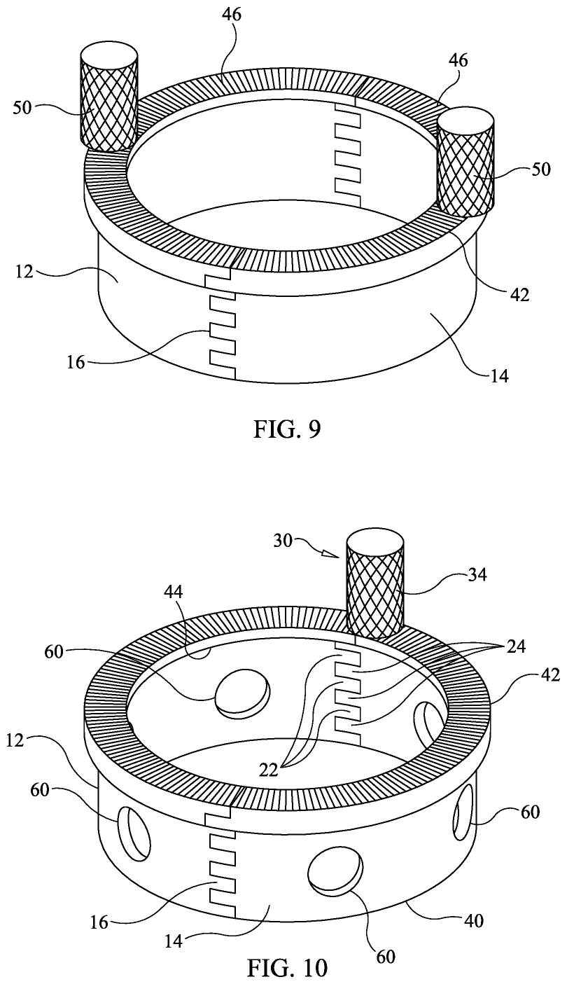

In some embodiments of the present invention, one or more fixed-position knobs or posts can be provided on and coupled to axial end 42 where grooves 46 are located as shown in FIG. 9. For example, round or otherwise-shaped knobs or posts 50 can be coupled to axial end 42 at diametrically-opposed locations. Posts 50 can have knurled surfaces to improve one's grip therewith. Posts 50 could also be configured for engagement by a socket-type of tool that can, in turn, be used to apply axial pressure to the tool.

In some embodiments of the present invention and as shown in FIG. 10, a plurality of radially-extending through holes 60 can be provided in the radial walls of each of sections 12 and 14. Holes 60 serve as hooking locations should tool 10 be dropped in a location that is difficult to access for purposes of retrieval. The presence of holes 60 also serves to reduce the overall weight of tool 10.

The advantages of the present invention are numerous. The above-described tool provides for the safe manipulation and correct placement of a Wiggins-fitting sleeve on two pneumatic lines or fuel lines when the lines are placed end-to-end. The tool provides the means to drastically reduce the time it takes for an aircraft maintenance task that must be performed on a regular basis. The tool protects the Wiggins-fitting sleeve from damage to ensure the integrity of the ultimate line connection.

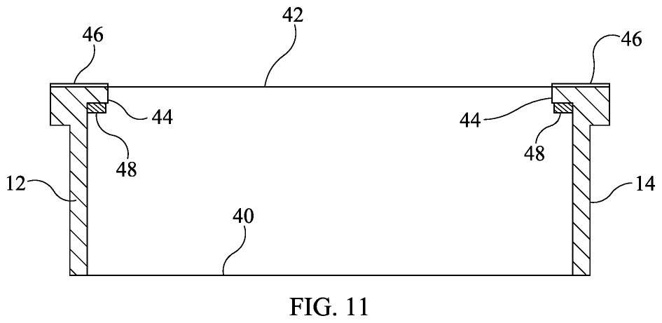

Although the invention has been described relative to specific embodiments thereof, there are numerous variations and modifications that will be readily apparent to those skilled in the art in light of the above teachings. For example, the above-described axial end 42 with grooves 46 could additionally or alternatively have several indentations in the form of “sockets” for engagement with a rigid rod to facilitate application of axial pressure to the tool during a sleeve manipulation and placement. In some embodiments of the present invention and as shown in FIG. 11, a cushion material 48 (e.g., rubber) can be disposed on interior annular ledge 44 for further protection of the axial end of a sleeve during an installation operation. It is therefore to be understood that, within the scope of the appended claims, the invention may be practiced other than as specifically described.

What is claimed as new and desired to be secured by Letters Patent of the United States is:

1. A tool, comprising:
an open-ended cylinder having a first half-cylinder and a second half-cylinder;
said first half-cylinder and said second half-cylinder hingedly coupled to one another at first circumferential ends thereof;
a retainer for coupling said first half-cylinder to said second half-cylinder at second circumferential ends thereof;
a first axial end of said open-ended cylinder adapted to slidingly receive an open-ended sleeve therein wherein the open-ended sleeve is fully encased by said open-ended cylinder; and
a second axial end of said open-ended cylinder having an annular ledge at an internal region of said open-ended cylinder adapted to prevent the open-ended sleeve from passing axially through said second axial end.

2. A tool as in claim 1, wherein an axial external end face of said second axial end of said open-ended cylinder includes indentations.

3. A tool as in claim 1, wherein an axial external end face of said second axial end of said open-ended cylinder includes radially-extending grooves.

4. A tool as in claim 1, further comprising at least one post coupled to said second axial end of said open-ended cylinder.

5. A tool as in claim 2, further comprising at least one post coupled to said axial external end face of said second axial end of said open-ended cylinder.

6. A tool as in claim 1, further comprising a plurality of through holes in radial walls of said open-ended cylinder.

7. A tool as in claim 1, wherein said retainer comprises a pin extending through said second circumferential ends of each of said first half-cylinder and said second half-cylinder.

8. A tool as in claim 1, further comprising a cushion material disposed on said annular ledge.

9. A tool as in claim 1, wherein said open-ended cylinder is adapted to be disposed about a conduit having an annular ferrule at the conduit's exterior surface, and wherein said annular ledge has an inside diameter that is greater than a diameter of the conduit and less than a diameter of the annular ferrule.

10. A tool, comprising:
an open-ended cylinder having a first half-cylinder and a second half-cylinder;
a hinge for coupling said first half-cylinder to said second half-cylinder at first circumferential ends thereof, wherein said hinge permits 90° of relative rotation between said first half-cylinder and said second half-cylinder;
a retainer for coupling said first half-cylinder to said second half-cylinder at second circumferential ends thereof;
a first axial end of said open-ended cylinder adapted to slidingly receive an open-ended sleeve therein wherein the open-ended sleeve is fully encased by said open-ended cylinder; and
a second axial end of said open-ended cylinder having an annular ledge at an internal region of said open-ended cylinder adapted to prevent the open-ended sleeve from passing axially through said second axial end.

11. A tool as in claim 10, wherein an axial external end face of said second axial end of said open-ended cylinder includes radially-extending grooves.

12. A tool as in claim 10, further comprising at least one post coupled to said second axial end of said open-ended cylinder.

13. A tool as in claim 11, further comprising at least one post coupled to said axial external end face of said second axial end of said open-ended cylinder.

14. A tool as in claim 10, further comprising a plurality of through holes in radial walls of said open-ended cylinder.

15. A tool as in claim 10, wherein said retainer comprises a pin extending through said second circumferential ends of each of said first half-cylinder and said second half-cylinder.

16. A tool as in claim 10, further comprising a cushion material disposed on said annular ledge.

17. A tool as in claim 10, wherein said open-ended cylinder is adapted to be disposed about a conduit having an annular ferrule at the conduit's exterior surface, and wherein said annular ledge has an inside diameter that is greater than a diameter of the conduit and less than a diameter of the annular ferrule.

18. A tool, comprising:
an open-ended cylinder having holes in radial walls thereof, said open-ended cylinder further having a first half-cylinder and a second half-cylinder;
a hinge for coupling said first half-cylinder to said second half-cylinder at first circumferential ends thereof, wherein said hinge permits 90° of relative rotation between said first half-cylinder and said second half-cylinder;
a retainer for coupling said first half-cylinder to said second half-cylinder at second circumferential ends thereof;
a first axial end of said open-ended cylinder adapted to slidingly receive an open-ended sleeve therein;
a second axial end of said open-ended cylinder having an annular ledge at an internal region of said open-ended cylinder adapted to prevent the open-ended sleeve from passing axially through said second axial end, wherein an axial distance between said first axial end and said annular ledge is at least as long as an axial length of the open-ended sleeve wherein said open-ended cylinder is adapted to fully encase the open-ended sleeve; and
said second axial end of said open-ended cylinder having an external end face that includes radially-extending grooves.

19. A tool as in claim 18, further comprising at least one post coupled to said second axial end of said open-ended cylinder.

20. A tool as in claim 18, wherein said retainer comprises a pin extending through said second circumferential ends of each of said first half-cylinder and said second half-cylinder.

21. A tool as in claim 18, further comprising a cushion material disposed on said annular ledge.

22. A tool as in claim 18, wherein said open-ended cylinder is adapted to be disposed about a conduit having an annular ferrule at the conduit's exterior surface, and wherein said annular ledge has an inside diameter that is greater than a diameter of the conduit and less than a diameter of the annular ferrule.
